(19) United States
(12) Patent Application Publication
(10) Pub. No.: US 2012/0096059 A1
(43) Pub. Date: Apr. 19, 2012

(54) STORAGE APPARATUS AND FILE SYSTEM MANAGEMENT METHOD

(75) Inventors: Masahiro Shimizu, Odawara (JP); Nobuyuki Saika, Yokosuka (JP)

(73) Assignee: HITACHI, LTD., Tokyo (JP)

(21) Appl. No.: 12/989,213

(22) PCT Filed: Oct. 13, 2010
(86) PCT No.: PCT/JP2010/006082

§ 371 Date: Oct. 22, 2010

(51) Int. Cl. G06F 17/30

(52) U.S. Cl. 707/828; 707/E17.01

(57) ABSTRACT

A storage apparatus is connected via a network to a host device which requests data writing. A file system is constructed on a virtual volume accessed by the host device. An assignment unit assigns a storage area of a plurality of storage devices to a data storage area of the file system; and an area management unit which, once the storage area of the plurality of storage devices has been assigned at least once to the data storage area of the file system, manages an area of the storage area from which data has been deleted and is no longer used by the file system as an assigned unused area. The assignment unit re-assigns the assigned unused area to the data storage area of the file system if the data writing to the data storage area of the file system from the host device has taken place.

### TECHNICAL FIELD

This invention relates to a storage apparatus and a file system management method and is suitably applied to a storage apparatus and file system management method with which assigned unused areas are effectively utilized in a virtual file system.

### BACKGROUND ART

Conventionally, a quota management function is used as a function for limiting the usage amount of disk capacity which is provided by a storage system. For example, by configuring a capacity restriction (quota) for each file system and each directory, pressure on the system as a result of a user's over-usage of disk capacity is prevented.

PTL 1 discloses a technology which configures a quota for each directory, independently detects expansion of the quotas for users, and assigns a storage area which is configured for a storage apparatus a limit value according to the result of comparing the limit value with the total value of the plurality of quotas.

In addition, by configuring the quotas for the file system directories, one physical file can be viewed virtually as a plurality of file systems. The virtual plurality of file systems will sometimes b described hereinafter as sub-trees. These sub-trees are presented to the user as a single file system.

Furthermore, in the storage apparatus, it is assumed that if file systems are provided to the user, the storage area in the storage apparatus will be efficiently used by means of a Thin Provisioning function which utilizes virtual volumes (these will be referred to hereinafter as virtual volumes). In Thin Provisioning, if the virtual volume is presented to a host device and there is write access to the virtual volume from the host device, a physical storage area for actually storing data is assigned to the virtual volume. As a result, the storage area in the storage apparatus can be used efficiently while a volume of a capacity equal to or greater than the storage area in the storage apparatus is presented to the host device. The assignment of a physical storage area to the virtual volume will sometimes be described hereinafter as allocation processing.

PTL 2 discloses presenting a virtual volume to a host device, assigning a physical storage area to the area of the virtual volume, and then detecting that there is a reduced need to maintain this assignment and releasing the assignment of the physical storage area according to the detection result. As a result of the technology disclosed in PTL 2, once the storage area assigned to the virtual volume is no longer being used, effective usage of the storage resources can be achieved by releasing the assignment of the storage area.

### CITATION LIST

### Patent Literature

### [PTL 1]

Japanese Unexamined Patent Application Publication No. 2009-75814

### [PTL 2]

Japanese Unexamined Patent Application Publication No. 2007-310861

### SUMMARY OF INVENTION

### Technical Problem

However, in a sub-tree for which the write access frequency by the host is high, if writing to the area of the virtual volume to which physical storage area has not been assigned occurs frequently, allocation processing or the like, in which physical storage area is assigned to the virtual volume, arises frequently. As a result, there is a load on a disk array device which manages a plurality of disks and a drop in the processing performance, which is problematic.

The present invention was conceived in view of the foregoing and proposes a storage apparatus and file system management method with which the load in data write processing can be reduced and the processing performance improved by suitably re-using the storage area assigned to the virtual volume according to the file system usage characteristics.

### Solution to Problem

In order to solve these problems, the present invention provides a storage apparatus which is connected via a network to a host device which requests data writing, comprising a file system construction unit which constructs a file system on a virtual volume accessed by the host device; an assignment unit which assigns a storage area of a plurality of storage devices to a data storage area of the file system in response to the data writing request from the host device; and an area management unit which, once the storage area of the plurality of storage devices has been assigned at least once to the data storage area of the file system, manages an area of the storage area from which data has been deleted and is no longer used by the file system as an assigned unused area as is while maintaining the assignment of the storage area of the plurality of storage devices, wherein the assignment unit re-assigns the assigned unused area to the data storage area of the file system if the data writing to the data storage area of the file system from the host device has taken place.

With this configuration, a file system is constructed in a virtual volume accessed by the host device and a storage area of a plurality of storage devices is assigned to a data storage area of the file system in response to the data writing request from the host device; and, once the storage area of the plurality of storage devices has been assigned at least once to the data storage area of the file system, an area of the storage area from which data has been deleted and is no longer used by the file system is re-assigned to the data storage area of the file system if the data writing has taken place as an assigned unused area as is while maintaining the assignment of the storage area of the plurality of storage devices. As a result, assigned unused areas are effectively utilized, whereby the load on the whole system in data write processing can be reduced and the processing performance can be improved.

### Advantageous Effects of Invention

According to the present invention, the load in data write processing can be reduced and the processing performance can be improved.

### BRIEF DESCRIPTION OF DRAWINGS

FIG. 1 is a conceptual view providing an overview of file systems according to an embodiment of the present invention.

FIG. 2 is a conceptual view providing an overview of sub-trees according to this embodiment.

FIG. 3 is a conceptual view illustrating re-usage of assigned unused areas according to this embodiment.

FIG. 4 is a block diagram showing a hardware configuration of a storage system according to this embodiment.

FIG. 5 is a conceptual view showing details of a Thin Provisioning function according to this embodiment.

FIG. 6 is a diagram showing content of a page management table according to this embodiment.

FIG. 7 is a diagram showing content of a virtual volume configuration table according to this embodiment.

FIG. 8 is a diagram showing content of a real address management table according to this embodiment.

FIG. 9 is a block diagram showing a software configuration of a storage system according to this embodiment.

FIG. 10 is a conceptual view showing the configuration of a file system according to this embodiment.

FIG. 11 is a diagram showing content of an inode management table according to this embodiment.

FIG. 12 is a conceptual view of a reference example of an inode-based data block according to this embodiment.

FIG. 13 is a conceptual view showing the details of an inode management table according to this embodiment.

FIG. 14 is a diagram showing content of a sub-tree quota management table according to this embodiment.

FIG. 15 is a conceptual view showing the layer structure between a virtual file system and hard disk according to this embodiment.

FIG. 16 is a diagram showing content of a state management table according to this embodiment.

FIG. 17 is a diagram showing content of a mapping table according to this embodiment.

FIG. 18 is a diagram showing content of a quota management table according to this embodiment.

FIG. 19 is a conceptual view of the content of an access log according to this embodiment.

FIG. 20 is a conceptual view showing an overview of file system construction processing according to this embodiment.

FIG. 21 is a conceptual view showing an overview of write request reception processing according to this embodiment.

FIG. 22 is a conceptual view illustrating recovery processing of assigned unused areas according to this embodiment.

FIG. 23 is a conceptual view illustrating monitoring processing of assigned unused areas according to this embodiment.

FIG. 24 is a block diagram showing a program of a file storage device according to this embodiment.

FIG. 25 is a flowchart showing file system construction processing according to this embodiment.

FIG. 26 is a flowchart illustrating processing for allocating assigned unused areas according to this embodiment.

FIG. 27 is a flowchart showing read/write request reception processing of data according to this embodiment.

FIG. 28 is a flowchart showing read/write request reception processing of data according to this embodiment.

FIG. 29 is a flowchart showing data acquisition processing according to this embodiment.

FIG. 30 is a flowchart showing data storage processing according to this embodiment.

FIG. 31 is a flowchart showing mapping table update processing according to this embodiment.

FIG. 32 is a flowchart showing data migration processing according to this embodiment.

FIG. 33 is a flowchart illustrating processing for monitoring the assignment amount of assigned unused areas according to this embodiment.

FIG. 34 is a flowchart showing storage area return reception processing according to this embodiment.

FIG. 35 is a flowchart showing stub file recall processing according to this embodiment.

### DESCRIPTION OF EMBODIMENTS

An embodiment of the present invention will be described in detail hereinbelow with reference to the drawings.

### (1) Overview of the Embodiment

In this embodiment, by configuring a quota for each file system directory, a single physical file is virtually rendered a plurality of file systems (sub-trees). Furthermore, a Thin Provisioning function is applied to a physical file system which comprises a plurality of sub-trees.

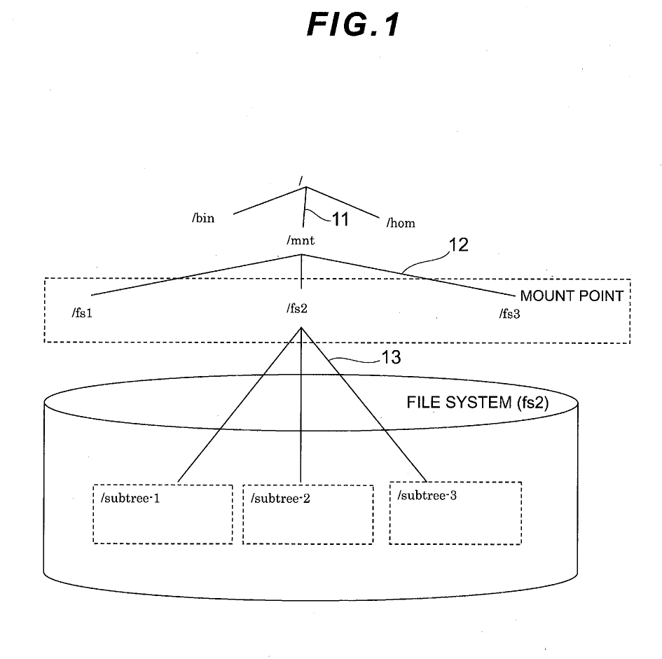

Foremost, a virtual file system (sub-tree) according to this embodiment will be described. Specifically, as shown in FIG. 1, by configuring a quota for each of the directories which are directly under a mount point 11 (abbreviated to mnt in the drawings), which is the top directory in the file system, the usage capacity of each directory can be restricted. The directories which are directly under the mount point 11 are called sub-trees (abbreviated to sub-trees in the drawings), and a plurality of sub-trees can be configured. In FIG. 1, if a file system (fs2) is mounted at a mount point (/mnt/fs2), three sub-trees are created directly under the file system (fs2) and a quota is configured for each sub-tree.

The relationship between the virtual volume provided by the Thin Provisioning function and the virtual file system (sub-trees) will be explained next. With the Thin Provisioning function, one or more logical volumes are defined by one or more hard disk drives (HDDs). Further, a single pool is constructed from one or more logical volumes and one or more virtual volumes are associated with each of the pools.

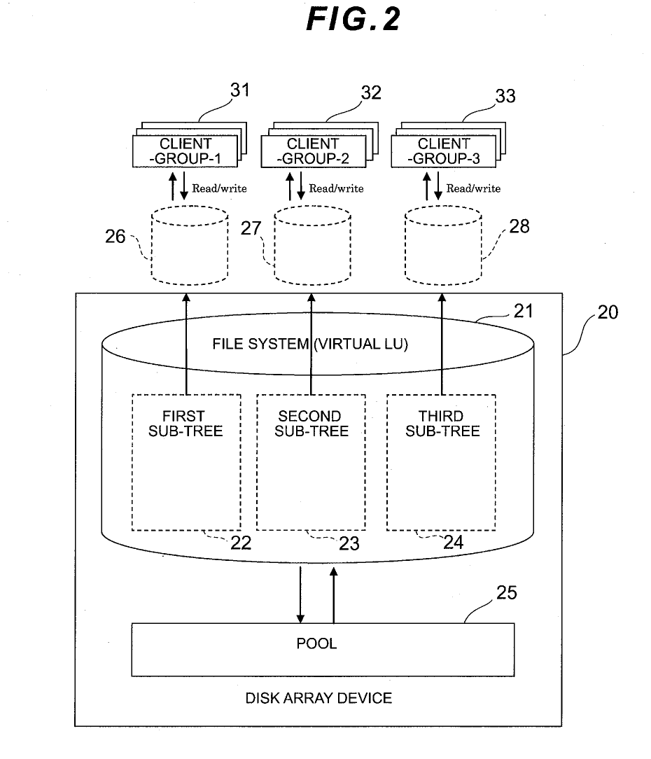

Furthermore, as shown in FIG. 2, a file system 21 is created on a virtual volume. By configuring a quota for each directory, the file system 21 is viewed virtually as a plurality of file systems (a first sub-tree 22, a second sub-tree 23, and a third sub-tree 24). By configuring file sharing for each of the sub-trees, the user is able to handle each sub-tree as a single file system.

Furthermore, if file access is performed by the user, the storage area of a pool 25 is assigned dynamically to the accessed areas of each sub-tree. In addition, once assigned, storage areas which are no longer being used are returned to the pool 25. Conventionally, the assignment of a pool storage area by data writing and the return of unused storage areas to the pool has not been carried out according to the characteristics of the sub-trees but rather the assignment and return of storage areas have been performed globally for all sub-trees. For this reason, if data writing occurs frequently, processing to assign storage areas occurs frequently due to the writing, which places a load on the disk array device managing a plurality of disks and lowers the processing performance.

Hence, in this embodiment, by re-using storage areas which have been assigned but not used (hereinafter referred to as assigned unused areas) according to the sub-tree usage characteristics) between sub-trees, the assigned unused areas are utilized effectively and the load of the data write processing is reduced, whereby the processing performance is improved.

Specifically, in the storage system 100, three sub-trees, namely, a first sub-tree 111, a second sub-tree 112, and a third sub-tree 113, are configured in the file system 110.

For example, the first sub-tree 111 has a high data writing frequency, the second sub-tree has a low write frequency, and the third sub-tree has a write frequency which is not as high.

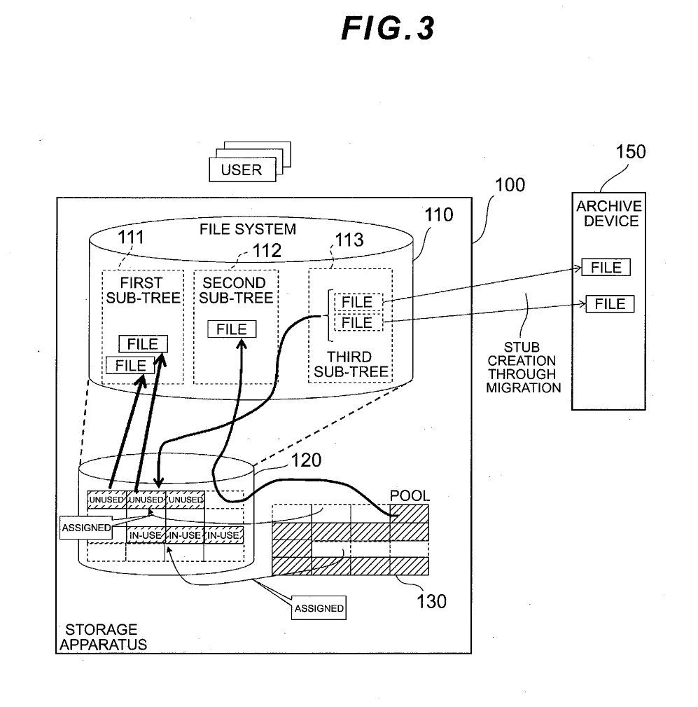

In this case, as shown in FIG. 3, if data is written to the first sub-tree 111 with the high write frequency, data is written to an assigned unused area. Furthermore, if data is written to the second sub-tree 112 with the low write frequency, normal data write processing due to assignment processing is executed. Furthermore, after being assigned to the second sub-tree 112, assigned unused areas that are no longer being used are utilized during data writing of the first sub-tree 111. Further, if data is written to the third sub-tree 113, processing to write normal data is executed, and assigned unused areas which are no longer used are re-used by themselves.

Here, examples of a case where areas once assigned are no longer used and assigned unused areas are generated include, for example, a case where data which has undergone stub generation is substantiated and files are deleted as a result of data migration processing.

By limiting re-usage of assigned unused areas according to sub-tree characteristics in this way, assigned unused areas can be effectively utilized. For example, by proactively re-using assigned unused areas for the first sub-tree 111 with a high write frequency, the load of data write processing can be reduced. In addition, by using assigned unused areas generated in the second sub-tree 112 with a low write frequency for the first sub-tree 111 rather than for the second sub-tree 112, assigned unused areas can be utilized effectively.

For example, when assigned unused areas are proactively used in cases where the second sub-tree 112 is used in processing which is unrelated to user access such as nightly batch, there are very few assigned unused areas which are re-used for the first sub-tree 111. Hence, as is the case for the second sub-tree 112, for processing which barely affects deterioration in the response to user access, usage of assigned unused areas is restricted since are no system-related problems even when write processing takes time. In this embodiment, assigned unused area usage restrictions will be described hereinbelow under the term quota management.

In addition, a case is also assumed where the sub-tree characteristics change according to the state of usage by the user. For example, a state is assumed where the write frequency of the first sub-tree 111 is low and the usage frequency of the second sub-tree 112 is high. In this case, the restrictions (quota) on usage of the assigned unused areas are changed to enable assigned unused areas to be utilized effectively by releasing the quota of the second sub-tree 112 and reconfiguring the quota of the first sub-tree 111.

### (2) Storage System Hardware Configuration

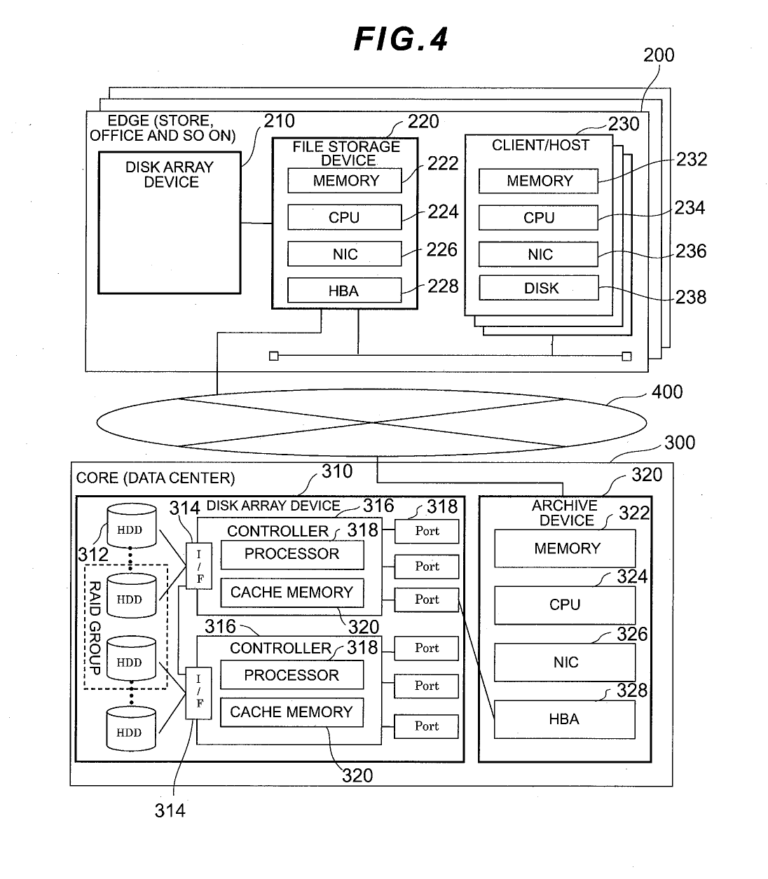

FIG. 4 shows the hardware structure of the storage system 100. The storage system 100 mainly comprises a file storage device 220 for providing files to a client/host 230 and a disk array device 310 for restricting the writing and so on of data to the plurality of hard disk drives (HDD).

In this embodiment, the file storage device 220 and disk array device 210 are configured as separate devices but the present invention is not limited to this example; the file storage device 220 and disk array device 210 may also be integrally configured as a storage apparatus. Furthermore, in this embodiment, the point at which the user, i.e. store or business person, actually conducts business is generally referred to as Edge 200 and the point from which the server and storage apparatus used in the enterprise or the like are collectively managed and a data center providing cloud services will be referred to generally as Core 300.

The Edge 200 and Core 300 are connected via a network 400. The network 400 is configured from a SAN (Storage Area Network) or the like, for example, and inter-device communications are executed in accordance with the Fibre Channel Protocol, for example. Furthermore, the network 400 may also be LAN (Local Area Network), the Internet, a public line or a dedicated line or similar, for example. If the network 400 is a LAN, inter-device communications are executed in accordance with the TCP/IP (Transmission Control Protocol/Internet Protocol) protocol, for example.

The Edge 200 is configured from the disk array device 210, the file storage device 220, and the client/host 230 and so on.

The file storage device 220 comprises a memory 222, a CPU 224, a network interface card (abbreviated to NIC in the drawings) 226, and a host bus adapter (abbreviated to HBA in the drawings) 228 and the like.

The CPU 224 functions as an arithmetic processing unit and controls the operation of the file storage device 220 in accordance with programs and computational parameters and the like which are stored in the memory 222. The network interface card 226 is an interface for communicating with an archive device 320 via the network 400. Furthermore, the host bus adapter 228 connects the disk array device 210 and file storage device 220, and the file storage device 220 performs block unit access to the disk array device 210 via the host adapter 228.

The disk array device 210 includes a plurality of hard disk drives, receives data I/O requests transmitted from the host bus adapter 228, and executes data writing or reading. The internal configuration of the disk array device 210 is the same as that of the disk array device 310 and will be described in detail subsequently.

The Core 300 is configured from the disk array device 310 and the archive device 320 and so on. The disk array device 310 is configured from a plurality of hard disk drives 312, a plurality of controllers 316, a plurality of ports (abbreviated to Ports in the drawings) 318, and a plurality of interfaces (abbreviated to I/F in the drawings) 314.

The controllers 316 are configured from a processor 318 for controlling data I/Os and a cache memory 320 for temporarily storing data. In addition, the port 318 is a channel interface board which includes a channel adapter (CHA) function and functions as a so-called channel adapter (CHA) for connecting the controller 316 and archive device 320. The port 318 includes a function for transferring commands received from the archive device 320 via a local router (not shown) to the controller 316.

In addition, the interfaces 314 are hard disk interface boards which include a disk adapter (DKA) function. The interfaces 314 execute the data transfer of commands sent to the hard disks 312 via a local router (not shown). In addition, the controllers 316, interfaces 314, and ports 318 may be mutually connected by switches (not shown) and may distribute commands or other data.

One or more logical volumes (LDEV) are configured on the storage areas provided by the plurality of hard disks 312. The plurality of hard disks 312 are managed as a single RAID group, and one or more logical volumes are defined on the storage area provided by the RAID group. Furthermore, logical volumes which are provided by a plurality of RAID groups are managed as a single pool. Normally, when creating a logical volume, the storage area in the hard disk is assigned to the logical volume but if the frequency with which the host (user) uses the logical volume, to which the storage area is assigned, is small, the assigned storage area is not used effectively. Hence, when a data write request is received from the host (user), the Thin Provisioning function, which assigns hard disk storage areas, is used first.

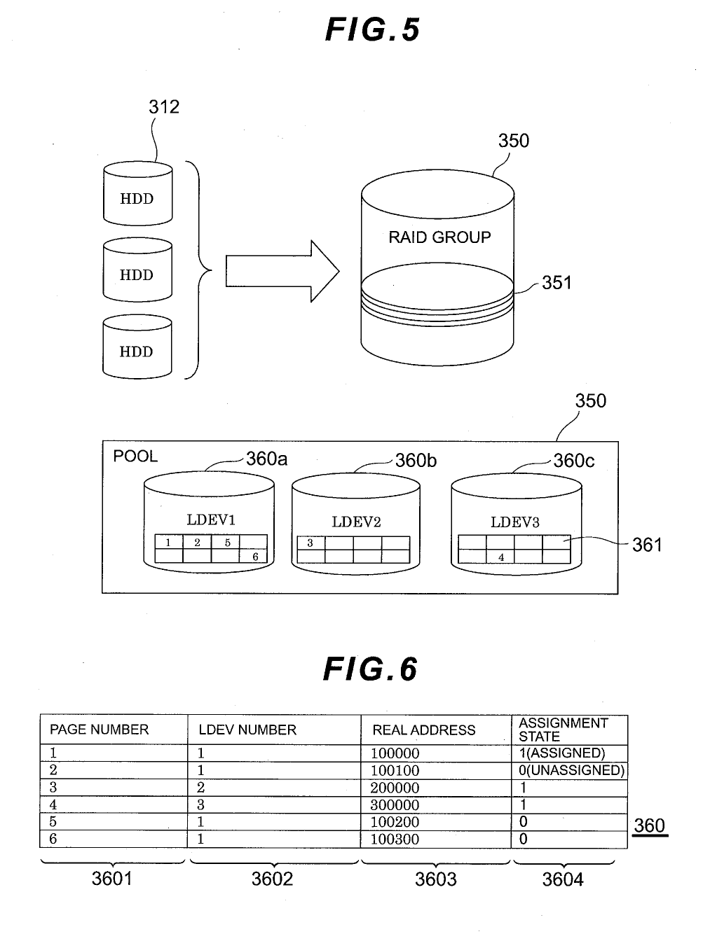

Details of the Thin Provisioning function which is provided by the disk array devices 210 and 310 will now be provided with reference to FIG. 5. The disk array device 210 and disk array device 310 include the same functions and therefore the disk array device 310 will be described by way of example hereinbelow.

As shown in FIG. 5, in Thin Provisioning, a RAID group which is configured from the plurality of hard disk drives 312 is treated as a single logical volume 350 and is managed as a pool 360. A plurality of logical volumes (LDEV) 351 exist in the pool 360 and the logical volumes (LDEV) 351 in the pool 360 are managed in page (fixed-length storage area) 361 units.

Page numbers identifying pages are assigned to each of the pages 361 and the page numbers are mapped to the page management table 360 in association with logical volume numbers (LDEV numbers) and logical volume real addresses. The page management table 360 is a table for managing the mapping and assignment states of the logical volume pages and, as shown in FIG. 6, is configured from a page number field 3601, an LDEV number field 3602, a real address field 3603, and an assignment state field 3604.

The page number field 3601 stores the page numbers of the logical volumes. The LDEV number field 3602 stores numbers identifying logical volumes. The real address field 3603 stores real addresses on the logical volumes. The assignment state field 3604 stores information indicating whether or not a virtual volume (described subsequently) has been assigned; if a virtual volume has already been assigned, a flag 1 indicating assignment is stored if a virtual volume has already been assigned, and if a virtual volume has not yet been assigned, a flag 0 indicating non-assignment is stored.

However, a virtual volume to which a storage area has not been assigned is provided to the host (user). The virtual volumes are managed by a virtual volume configuration table 370 which maps virtual volume addresses with page numbers.

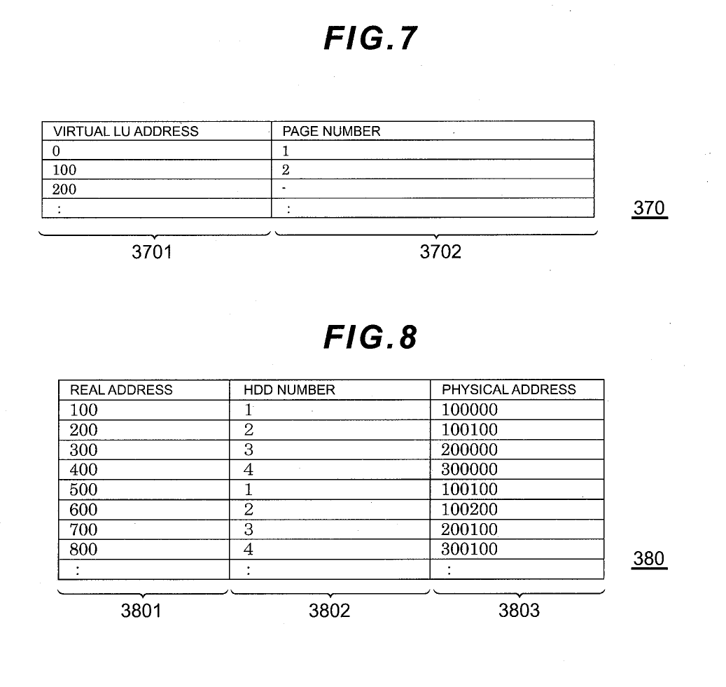

As shown in FIG. 7, the virtual volume configuration table 370 is configured from a virtual LU address field 3701 and a page number field 3702. The virtual LU address field 3701 stores addresses of the virtual volumes. The page number field 3702 stores the page numbers of the logical volumes.

Upon receiving a request to write data to the virtual volume from the client/host 230, the disk array device 310 refers to the virtual volume configuration table 370 and specifies the page number of the logical volume corresponding to the virtual volume address received from the client/host 230. Furthermore, if a page number corresponding to the address of the designated virtual volume has been configured in the virtual LU configuration table 370, the disk array device 310 refers to the page management table 360 and acquires the LDEV number and real address which correspond to the page number and stores data in the storage area corresponding to the real address.

Furthermore, if a page number corresponding to the address of the designated virtual volume has not been configured in the virtual LU configuration table 370, the disk array device 310 specifies a page number for which the assignment state is unassigned from the page management table 360. The disk array device 310 then acquires the LDEV number and real address which correspond to the page number, and stores data in the storage area corresponding to the real address. The disk array device 310 then updates the value of the assignment state field 3604 of the page management table 360 from assigned 1 to unassigned 0, and stores the page number configured in the page number field 3702 of the virtual LU configuration table 370.

In addition, if a write request designating the logical volume number (LDEV number) and real address is generated, the disk array device 310 refers to the real address management table 380 created for each logical volume, specifies the hard disk and physical address, and executes write processing.

The real address management table 380 is configured, as shown in FIG. 8, from a real address field 3801, a HDD number field 3802, and a physical address field 3803. The real address field 3801 stores real addresses in the logical volumes. The HDD number field 3802 stores numbers identifying hard disks 312. The physical address field 3803 stores the physical addresses of the hard disks 312 corresponding to the real addresses stored in the real address field 3801.

Returning to FIG. 4, the archive device 320 comprises a memory 322, a CPU 324, a network interface card (abbreviated to NIC in the drawings) 326, and a host adapter (abbreviated to HBA in the drawings) 328 and so forth.

The CPU 324 functions as an arithmetic processing unit and controls the operation of the archive device 320 in accordance with programs and computational parameters and the like which are stored in the memory 322. The network interface card 326 is an interface for communicating with the file storage device 220 via the network 400. Furthermore, the host bus adapter 328 connects the disk array device 310 and archive device 320, and the archive device 320 executes block-unit access to the disk array device 310 via the host adapter 328.

### (3) Storage System Software Configuration

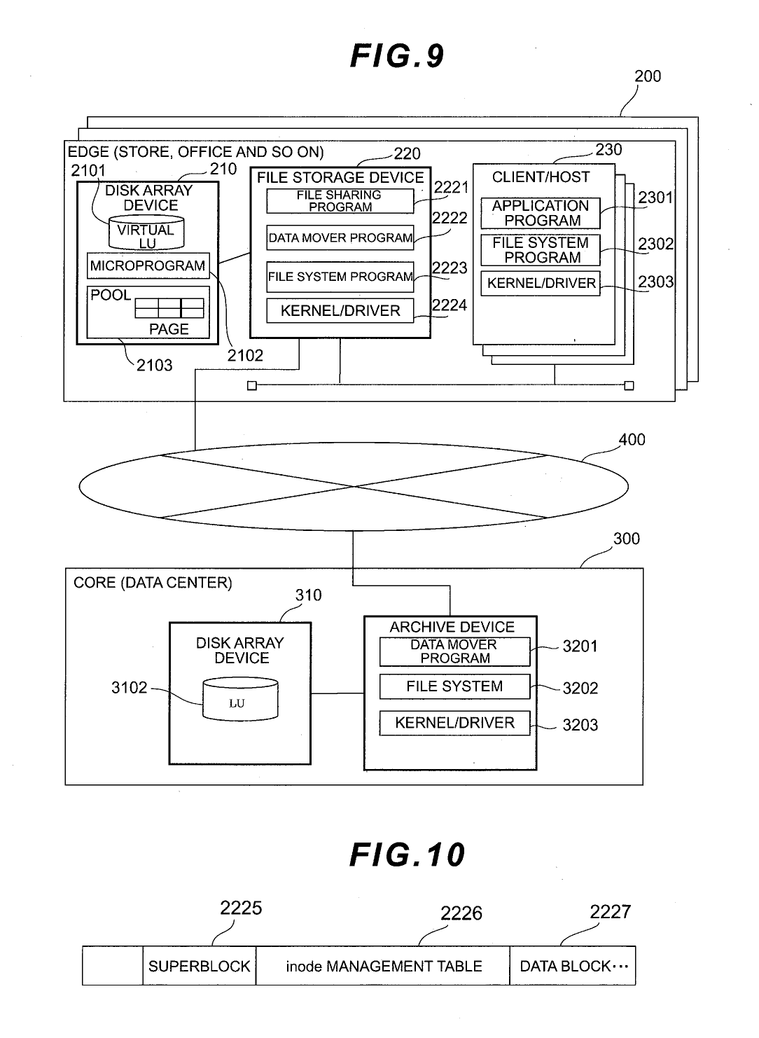

The software configuration of the storage system 100 will be explained next. As shown in FIG. 9, the memory of the disk array device 210 (not shown) stores a microprogram 2102. The microprogram 2102 is a program for providing a Thin Provisioning function to a client/host 230 and manages logical volumes, which are defined in a RAID group configured from a plurality of hard disks, as a single pool 2103. In addition, the microprogram 2102 presents a virtual volume (abbreviated to virtual LU in the drawings) 2101 to the client/host 230 and if there is write access by the client/host 230, assigns the area of the pool 2103 to the virtual volume 2101.

The memory 222 of the file storage device 220 stores a file sharing program 2221, a data mover program 2222, a file system 2223, and a kernel/driver 224.

The file sharing program 2221 is a program which uses a communication protocol such as CIFS (Common Internet File System) or NFS (Network File System), and provides a file sharing system with the client/host 230.

The data mover program 2222 is a program which transmits data which is migration target data to the migration destination archive device 320 from the migration source file storage device 220 when the data is migrated. In addition, the data mover program 222 comprises a function for acquiring data via the archive device 320 if a request is received to refer to data that has already been migrated to the archive device 320 from the client/host 230.

The file system program 2223 is a program for managing a logical structure which is constructed to implement management units known as files on a logical volume. The file system managed by the file system program 2223 is configured from a superblock 2225, an inode management table 2226, and a data block 2227 or the like, as shown in FIG. 10.

The superblock 2225 is an area which collectively holds information on the whole file system. Information on the whole file system is the size of the file system and the unused capacity of the file system, for example.

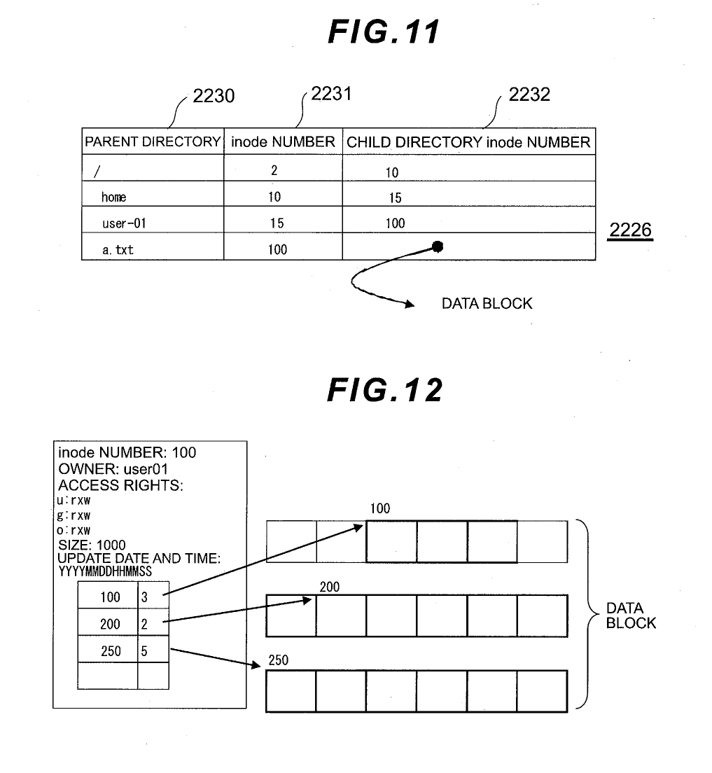

The inode management table 2226 is a table for managing inodes which are associated with a single directory or file. In cases where an inode where a file is stored is accessed, a directory entry which includes only directory information is used. For example, in cases where a file defined as home/user-01/a.txt is accessed, the data blocks are accessed by following the inode numbers which are associated with the directories, as shown in FIG. 11. In other words, the data block a.txt can be accessed by following the inode numbers 2, 10, 15, and then 100 in that order.

As shown in FIG. 12, the inode associated with the file entity a.txt stores information such as the file ownership rights, access rights, file size, and data storage point. Here, the reference relationship between the inodes and data blocks will be explained. As shown in FIGS. 12, 100, 200, and 300 in the drawings represent block addresses. In addition, 3, 2, and 5, which are associated with the block addresses, indicate the number of blocks from the address. Data is stored in this number of blocks.

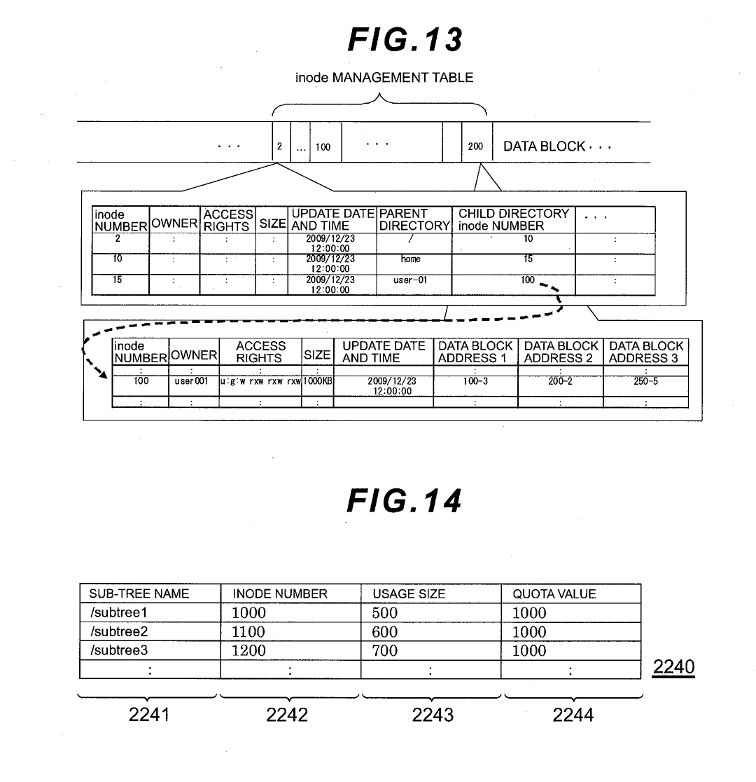

In addition, the inodes are stored, as shown in FIG. 13, in the inode management table. In other words, the inodes associated only with directories store inode numbers, update dates and times, and the inode numbers of the parent directories and child directories.

Furthermore, the inodes associated with file entities store not only inode numbers, update dates and times, parent directories, and child directories, but also owners and access rights, file sizes, and data block addresses and so on.

Returning to FIG. 10, the data blocks 2227 are blocks in which actual file data and management data and so on are stored.

Furthermore, in this embodiment, directories created directly under the physical file system are called sub-trees and the sub-trees are managed in the superblock 2225 of the physical file system. The sub-tree quota management table 2230 is stored in the superblock 2225.

The sub-tree quota management table 2230 is a table for managing the sub-tree quota and, as shown in FIG. 14, is configured from a sub-tree name field 2231, an inode number field 2232, a usage size field 2233, and a quota value field 2334. The sub-tree name field 2231 stores names for identifying sub-trees. The inode number field 2232 stores the inode numbers associated with the sub-trees. The usage size field 2233 stores the actual usage size of each sub-tree. The quota value field 2234 stores the quota value of each sub-tree and stores the limit values of the file capacities assigned to each sub-tree.

As mentioned earlier, the sub-trees can act like file systems with a capacity equal to the quota value by restricting the file capacity of the physical file system according to the quota value. Thus, the sub-tree defined by the quota value is called the virtual file system and the total of the quota values of each of the sub-trees is equal to or less than the capacity of the physical file system, that is, equal to or less than the size of the logical volume. The capacity restrictions on each of the sub-trees will be referred to hereinbelow as sub-tree quotas and the capacity restrictions on the aforementioned assigned unused areas will simply be explained under the name quota.

If the actual used sizes of each of the sub-trees are calculated, taking the inode numbers of the sub-trees as reference points, the inode management table can be calculated by totaling the file sizes included in the sub-trees in a lower level direction, that is, in a direction from the parent directory to the child directory.

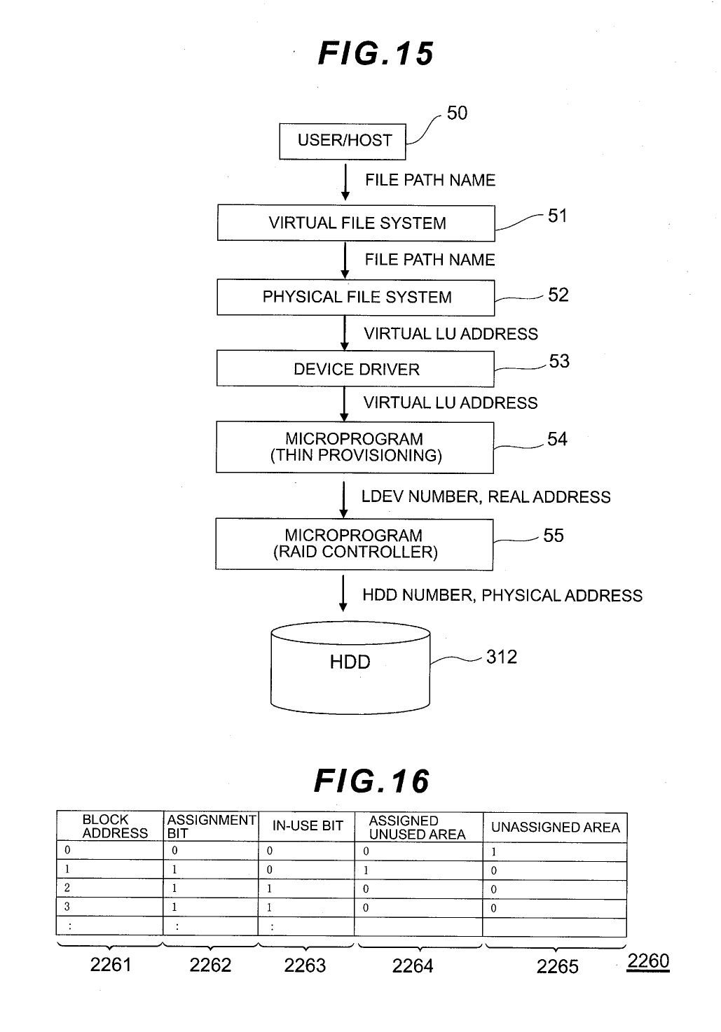

Now the layer structure between the virtual file system and the hard disks to which data is actually written will be described. As shown in FIG. 15, the file path name is first designated by the user or host 50. The file path name is access to the virtual file system 51 defined by restricting the file capacity of the physical file system. Access to the virtual file system 51 involves using the inode management table in the same way as when accessing the physical file system.

That is, the access destination file path name is converted into a block address of the virtual volume of the physical file system 52. The block address of the virtual volume is supplied to a device driver 53 of the disk array device 210.

Having received the virtual volume block address, the Thin Provisioning 54 of the microprogram 2102 in the disk array device 210 refers to the virtual volume configuration table 370 and converts the virtual volume block address into a page number which is associated with the block address.

The RAID controller 55 of the microprogram 2102 of the disk array device 210 refers to the page management table 360 and specifies the LDEV number and real address which correspond to the page number. The RAID controller 54 specifies the HDD number and physical address from the specified LDEV number and real address so that data is written to this address.

Returning to FIG. 9, the kernel/driver 2224 of the file storage device 220 is a program which executes overall control and hardware-specific control of the file storage device 220 such as scheduling control of the plurality of programs running on the file storage, control of interrupts from hardware, and block-unit I/Os to storage devices.

The memory 232 of the client/host 230 stores an application program 2301, a file system program 2302, and a kernel/driver 3303, and the like. The application program 2301 denotes various application programs which are executed on the client/host 230.

The file system program 2302 has the same function as the aforementioned file system program 2223 and therefore a detailed description is omitted here. The kernel/driver 3303 also comprises the same functions as the aforementioned kernel/driver 2224 and hence a detailed description is omitted here.

Moreover, the disk array device 310 of the Core 300 comprises substantially the same functions as the disk array device 210 of the Edge 200 and therefore a detailed description is omitted here.

### (4) Overview of Storage System Processing

Overview of the processing of the storage system 100 will be explained next. File system construction processing and sub-tree configuration processing will mainly be described hereinbelow and hence an overview of the processing of the file storage device 220 will be provided in particular detail.

Before providing an overview of the processing in the file storage device 220, a table which is stored in the memory 222 of the file storage device 220 will be described. The memory 222 stores a state management table 2260, a mapping table 2270, a quota management table 2280, and an access log 2290 and the like.

The state management table 2260 is a table which manages, for each sub-tree block, whether or not a pool storage area is assigned and whether or not the block is in use and, as shown in FIG. 16, is configured from a block address field 2261, an assignment bit field 2262, an in-use bit field 2263, an assigned unused area field 2264, and an unassigned area field 2265.

The block address field 2261 stores numbers identifying each of each of the block addresses. The assignment bit field 2262 stores either 1 which indicates that a corresponding block has been written to at least one or more times and storage area has been assigned, or 0 which indicates that writing has not been generated even once and storage area is unassigned. In addition, the in-use bit field 2263 stores 1 if data is stored in the corresponding block and is being used, or 0 if data has not been stored.

The assigned unused area field 2264 stores a value for the exclusive OR of the value stored in the assignment bit field 2262 and the value stored in the in-use bit field 2263. Therefore, if the exclusive OR of the value in the assignment bit field 2262 and the value of the in-use bit field 2263 is 1, the corresponding block is an assigned unused area. In other words, an assigned unused area in an area from which the data stored therein has been erased and which is unused but is an area in a state where the assignment is maintained of a block address corresponding to a file created directly under the sub-tree and the address of the logical volume (real volume).

Furthermore, the unassigned area field 2265 stores a value for the logical AND of the negative value of a value stored in the assignment bit field 2262 and the negative value of a value stored in the in-use bit field 2263. Therefore, if the logical AND of the negative value of the value in the assignment bit field 2262 and the negative value of the value in the in-use bit field 2263 is 1, this denotes an unassigned area for which the logical volume address has not been assigned to the corresponding block address even once.

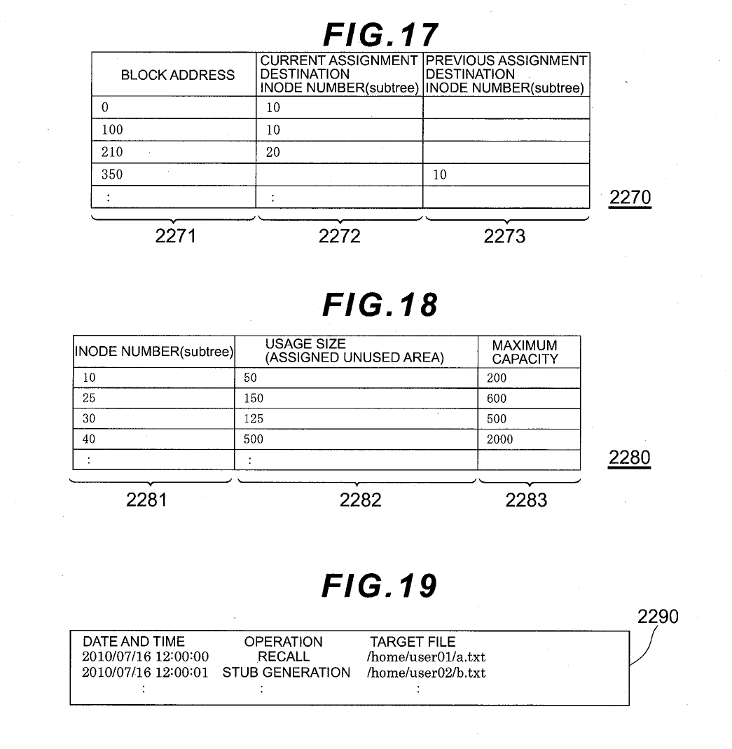

In addition, the mapping table 2270 is a table for managing the associations between sub-tree inode numbers and block addresses of assigned unused areas for which sub-trees are available and, as shown in FIG. 17, is configured from a block address field 2271, a current assignment destination inode number field 2272, and a previous assignment destination inode number field 2273.

The block address field 2271 stores numbers identifying each of the block addresses. The current assignment destination inode number field 2272 stores assigned sub-tree inode numbers. The previous assignment destination inode number field 2273 stores previously assigned sub-tree inode numbers.

In addition, the quota management table 2280 is a table for managing the maximum capacity of the assigned unused areas assigned to each of the sub-trees, and in-use assigned unused areas and, as shown in FIG. 18, is configured from an inode number field 2281, an assigned unused area usage size field 2282, and an assigned unused area maximum capacity 2283. The inode number field 2281 stores the sub-tree inode numbers. The usage size field 2282 stores the actual usage sizes of each of the assigned unused areas in each sub-tree. The maximum capacity field 2283 stores the maximum capacities of each of the assigned unused areas in each sub-tree. The limit value for assigned unused areas stored in the maximum capacity field 2283 is the quota of this embodiment.

The access log 2290 is a log for recording the dates and times when recall and stub generation are executed and, as shown in FIG. 19, details of operations such as recall and stub generation, target files which are the targets of these operations, and the dates and times when the operations were executed are sequentially recorded therein.

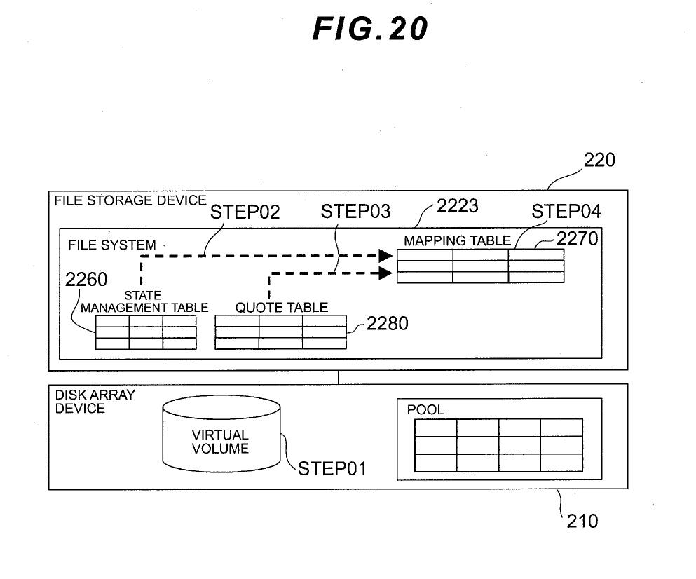

An overview of file system construction processing will be explained, next. As shown in FIG. 20, a RAID group is first created from a plurality of hard disks of the archive device 210 and logical volumes are created. Thereafter, the page management table 360 shown in FIG. 6 and the virtual volume configuration table 370 are created and virtual volumes are constructed. Furthermore, the inode management table 2226 and sub-trees are configured in a virtual volume and a virtual file system is constructed (STEP01).

Assigned unused areas are extracted by referring to the state management table 2260 (STEP02). The assigned unused areas are areas for which 1 is stored in the assigned unused area field 2264 of the state management table 2260. The allocation rate of the assigned unused areas is calculated from the quota management table 2280 (STEP03). The allocation rate of assigned unused areas can be calculated by dividing the maximum capacity of a sub-tree by the total value of the maximum capacities of the sub-trees.

The assigned unused areas are assigned to each of the sub-trees according to the allocation rate calculated in STEP03 (STEP04). When the assigned unused areas of each sub-tree are assigned, the sub-tree inode numbers are stored as current assignment destinations in the mapping table 2270 in FIG. 17.

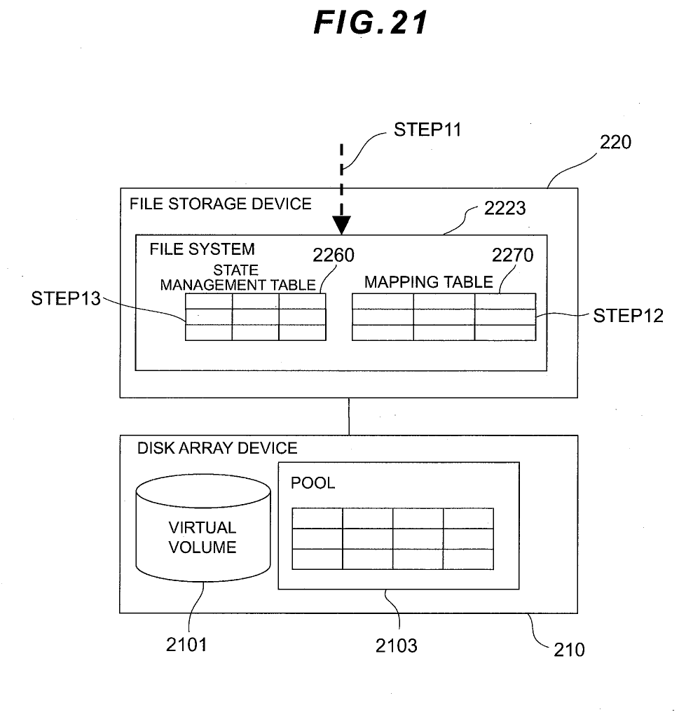

An overview of processing to receive a write request from the client/host 230 will be explained next. As shown in FIG. 21, the file storage device 220 first receives a write request from the client/host 230 (STEP11). When the write request is received in STEP11, the file data is stored in the virtual volume associated with each sub-tree.

When storing file data in the virtual volume, the file storage device 220 refers to the mapping table 2270 in FIG. 17 to acquire the block address of the assigned unused areas for which the sub-tree inode number is the current assignment destination, and writes the file data to that block (STEP12). In addition, if there are no assigned unused areas which are assignment destinations in the mapping table 2270, the file storage device 220 refers to the state management table 2260 and writes data to an unassigned area (STEP13).

When data is written to an unassigned area, the archive device 210 stores file data to a physical storage area by assigning a storage area in the pool 2103 to the virtual volume 2101.

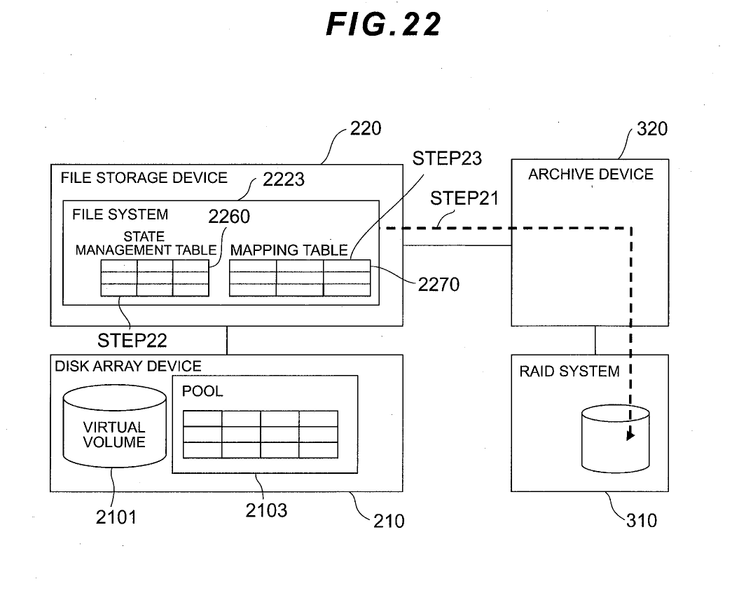

Processing to recover an assigned unused area will be described next. As shown in FIG. 22, file data stub generation is generated in each sub-tree due to the migration of file data (STEP21). If file data stub generation is generated, the storage area where file data is stored is released after being assigned to the sub-tree. As a result, this area is an assigned unused area for which 1 is stored in the sub-tree assignment bit field 2262 of the state management table 2260 and 0 is stored in the in-use bit field 2263, and hence 1 is stored in the assigned unused area field 2264 (STEP22).

Furthermore, block addresses of areas which are assigned unused areas in STEP22 are added to the mapping table 2270 (STEP23). When the block addresses of assigned unused areas are added to the mapping table 2270, these areas can be re-used by other sub-trees.

Sub-tree classification processing will be explained next. Sub-trees are classified into type-1 first sub-trees, type-2 second sub-trees, and type-3 third sub-trees on the basis of the number of stubs in the sub-tree, and the average of the periods for stub generation of files in each sub-tree. The average of the stub generation periods can be calculated from the date and time of the aforementioned log files 2290.

First, the first sub-tree classified as type 1 will be explained. Sub-trees which frequently undergo data writing are classified as type-1 first sub-trees. Sub-trees which frequently undergo data writing include, for example, sub-trees which have a small number of stubs and for which the average stub generation period for files in the sub-tree is short.

If data is written to a file in a type-1 first sub-tree, the data is written by way of priority to assigned unused areas. Furthermore, assigned unused areas, which has been assigned once to a type-2 second sub-tree and are no longer used, are also reserved by way of priority as a data write area of a type-1 first sub-tree.

Sub-trees which not frequently subjected to data writing are classified as type-2 second sub-trees. Sub-trees which do not frequently undergo data writing include, for example, sub-trees which have a large number of stubs and for which the average stub generation period for files in the sub-tree is long.

If data is written to a type-2 second sub-tree file, the data is always written to an unassigned area. As mentioned hereinabove, since the second sub-tree classified as type 2 has a high establishment of stub generation, and hence an assigned unused area can be secured through stub generation. In addition, writing to an unassigned area is performed by speculatively recalling the type-2 second sub-tree when user access is limited. As a result, if not used for a fixed period, data is deleted as a result of stub generation and a multiplicity of assigned unused areas can be reserved. The assigned unused area which is reserved through stub generation of the type-2 second sub-tree is provided to the type-1 first sub-tree.

Furthermore, sub-trees which do not belong to type 1 or type 2 are classified as type-3 third sub-trees. That is, sub-trees for which data writing is not performed as frequently as for type-1 first sub-trees and with a higher data writing frequency than type-2 second sub-trees are classified as type 3. For type-3 third sub-trees, data can be written to assigned unused areas within a range which is assigned to its own sub-tree. In other words, the assigned unused area which is reserved through stub generation of the type-3 third sub-tree can be used by the type-3 third sub-tree itself. Furthermore, in cases where there are no more assigned unused areas, which can be used by the type-3 third sub-tree, an unassigned area is used.

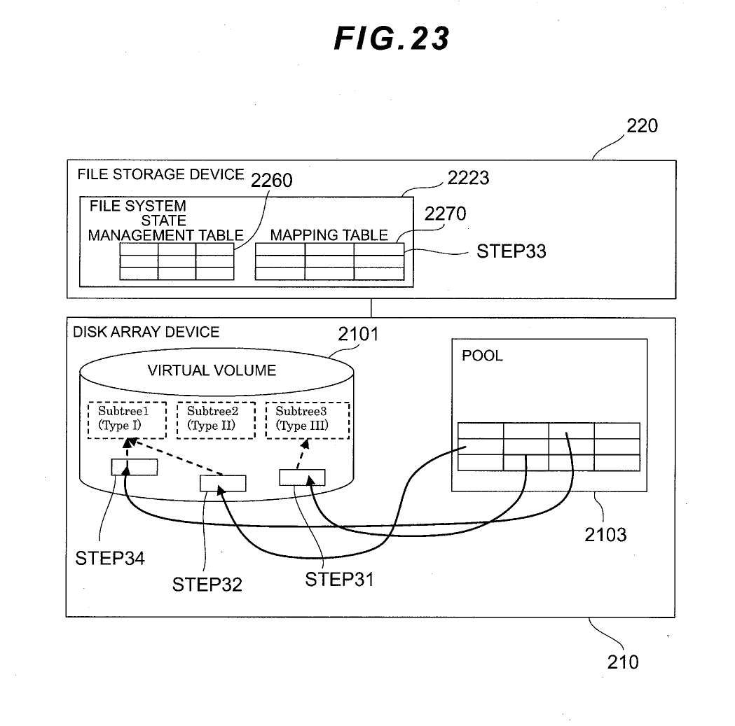

Processing to monitor an assigned unused area of each sub-tree and processing to re-assign/return assigned unused area will be described next. As shown in FIG. 23, assigned unused areas which have not been assigned to sub-trees are monitored first (STEP31). Assigned unused areas which have not been assigned to sub-trees are assigned unused areas for which an inode number has not been configured in the current assignment destination inode number field in the mapping table 2270.

If the assigned unused areas reach a fixed amount in STEP31, assigned unused area re-assignment is performed according to the type of each sub-tree (STEP32). For example, in the case of an assigned unused area which has not been assigned to a sub-tree and where a type-1 or type-3 sub-tree is used, assigned unused areas are assigned to the type-1 or type-3 respectively. In addition, in the case of an assigned unused area which has not been assigned to a sub-tree and where type-2 is used, an assigned unused area is assigned to type-1.

As mentioned earlier, after an assigned unused area has been re-assigned to a suitable sub-tree, the mapping table 2270 is updated (STEP33). The update of the mapping table 2270 after the re-assignment of the assigned unused area involves storing the sub-tree inode numbers which have been re-assigned to the current assignment destination inode number field 2272 in the mapping table 2270, for example.

In addition, if there is room in the assignment unused area assigned to the type-1 or type-3 sub-tree, this area is returned to the archive device 210. When there is room in the assigned unused area, this represents a case where assigned unused area has been assigned in excess of the capacity of the assigned unused area that needs to be assigned to the type-1 or type-3 sub-tree. As mentioned earlier, each of the sub-trees has a limited file capacity (sub-tree quota) assigned to each sub-tree according to the sub-tree quota management table 2230. Hence, if assigned unused area is assigned in excess of the sub-tree quota, this area is returned to the archive device 210.

### (4) Details of the Operation of the File Storage Device

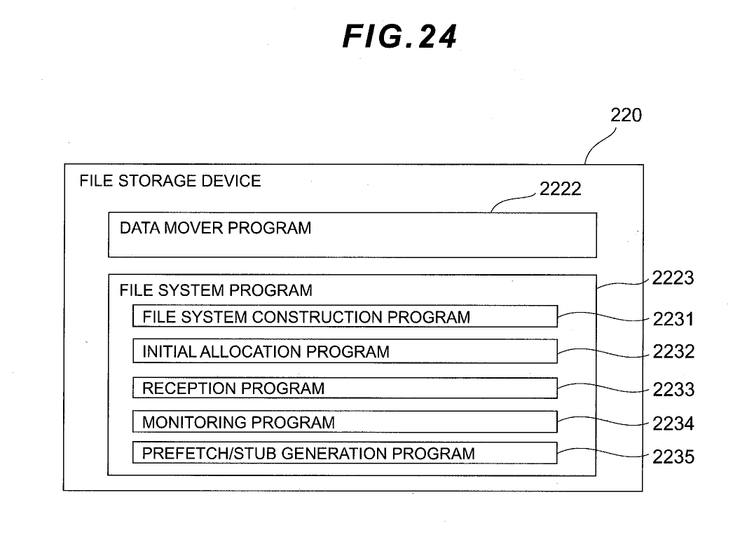

Details of the operation of the file storage device 220 will be provided next. The data mover program 2222 and file system program 2223 which are stored in the memory 222 of the file storage device 220 will be described in particular detail hereinbelow. As shown in FIG. 24, the file system program 2223 further comprises a file system construction program 2231, an initial allocation program 2232, a reception program 2233, a monitoring program 2234, and a prefetch/stub generation program 2235, and so on.

It goes without saying that, although the following description of the various processing will be centered on the programs, in reality it is the CPU 224 of the file storage device 220 that executes this processing based on these programs.

The file system construction program 2231 first creates sub-trees and constructs the file systems. The initial allocation program 2232 then allocates assigned unused area to each sub-tree. The reception program 2233 then receives a data write request from the client/host 230 and writes data to areas assigned to each sub-tree. Furthermore, the data mover program 2222 transfers files targeted for migration to the archive device and reserves assigned unused area. The monitoring program 2234 then monitors the assignment amount of the assigned unused area which is assigned to each sub-tree. The prefetch/stub generation program 2235 searches for sub-tree stub files and recalls the retrieved stub files. Thus, in a plurality of sub-trees created in a file system, the reserved assigned unused areas can be used adaptively according to the usage characteristics of each sub-tree.

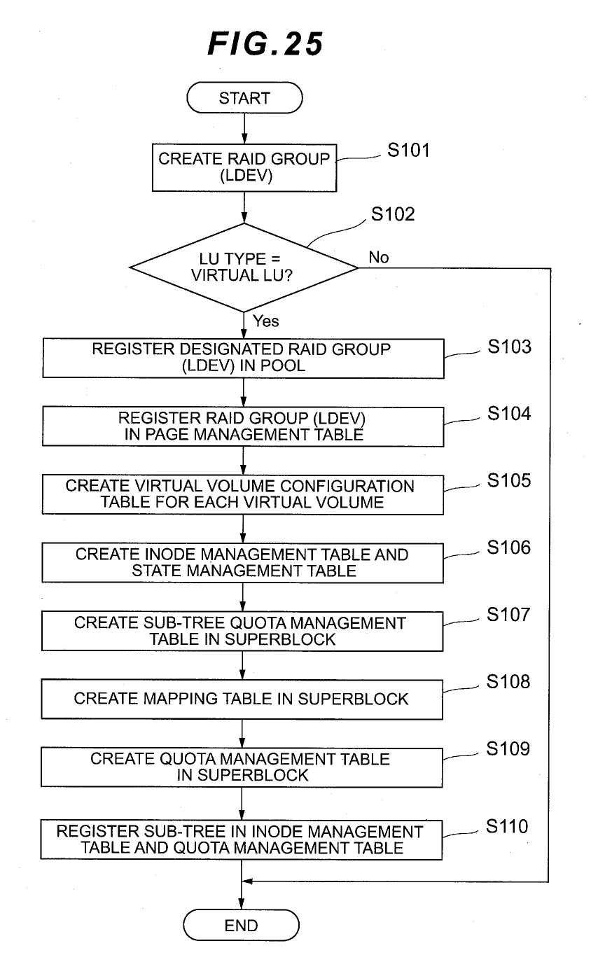

As shown in FIG. 25, the file system construction program 2231 first creates a RAID group (S101). Specifically, the file system construction program 2231 renders a single RAID group from a plurality of hard disks, and defines one or more logical volumes (LDEV) in the storage areas provided by the RAID group.

The file system construction program 2231 determines whether or not the types of logical volumes (LU) provided to the client/host 230 are virtual volumes (virtual LU) (S102). In step S102, the file system construction program 2231 ends the processing if it is determined that the type of the logical volume (LU) is not a virtual volume.

However, if the file system construction program 2231 determines in step S102 that the type of the logical volume (LU) is a virtual volume, the file system construction program 2231 registers the RAID group (LDEV) designated by the system administrator or the like via a management terminal in a predetermined pool (S103).

Furthermore, the file system construction program 2231 registers a RAID group in the page management table 360 (S104). Specifically, the file system construction program 2231 registers the LDEV number, real address, and assignment state of the RAID group in the page management table 360. The assignment state registers 0 which indicates an unassigned state.

In addition, the file system construction program 2231 creates a virtual volume configuration table 370 for each virtual volume provided to the client/host 230 (S105).

Specifically, the file system construction program 2231 registers virtual volume addresses in the virtual volume configuration table 370. The page numbers corresponding to the virtual volume addresses are configured when data is written and hence the page numbers are not registered.

Furthermore, the file system construction program 2231 creates an inode management table 2280 and a state management table 2260 (S106). More specifically, the file system construction program 2231 constructs a physical file system by registering the block addresses of the data blocks corresponding to the inode numbers in the inode management table 2280 and registering the block addresses in the state management table 2260.

The file system construction program 2231 then creates a sub-tree quota management table 2240 in the superblock 2225 (S107), creates a mapping table 2270 (S108), and creates a quota management table 2280 (S109).

Further, the file system construction program 2231 registers the sub-trees in the inode management table 2280 and quota management table 2280 (S110). Specifically, the file system construction program 2231 registers the inode numbers of the sub-trees in the inode management table 2280, and registers the inode numbers, and the usage sizes and maximum capacities of the assigned unused areas of the sub-trees in the quota management table 2280.

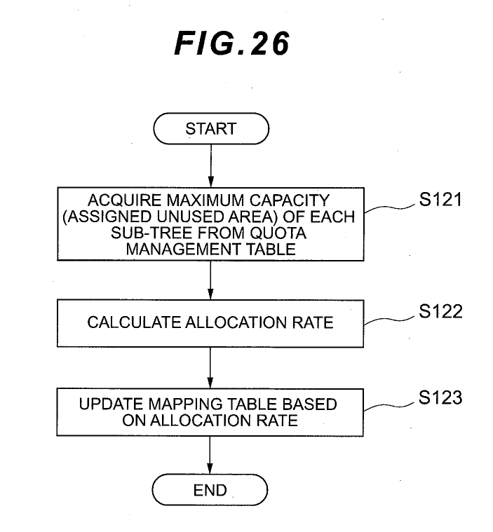

Processing to allocate assigned unused areas to each of the sub-trees by the initial allocation program 2232 will be described next. As shown in FIG. 26, the initial allocation program 2232 first acquires the maximum capacities of the assigned unused areas assigned to each of the sub-trees from the quota management table 2280 (S121).

The initial allocation program 2232 calculates the allocation rate of each of the sub-trees from the maximum capacities of the assigned unused areas of each of the sub-trees acquired in step S121 (S122). Specifically, the initial allocation program 2232 calculates the allocation rate by dividing the maximum capacities of each of the sub-trees by the total value of the maximum capacities of each of the sub-trees.

The initial allocation program 2232 then updates the mapping table 2270 based on the allocation rate calculated in step S122 (S123). Specifically, the initial allocation program 2232 stores the inode number which is the allocation destination in the current assignment destination inode number field corresponding to the block address registered in the mapping table 2270 as the assigned unused area.

As described earlier, the sub-trees, which are virtual files, are defined on the physical file system by means of the file system construction program 2231. Assigned unused areas are then assigned to each sub-tree by the initial allocation program 2232.

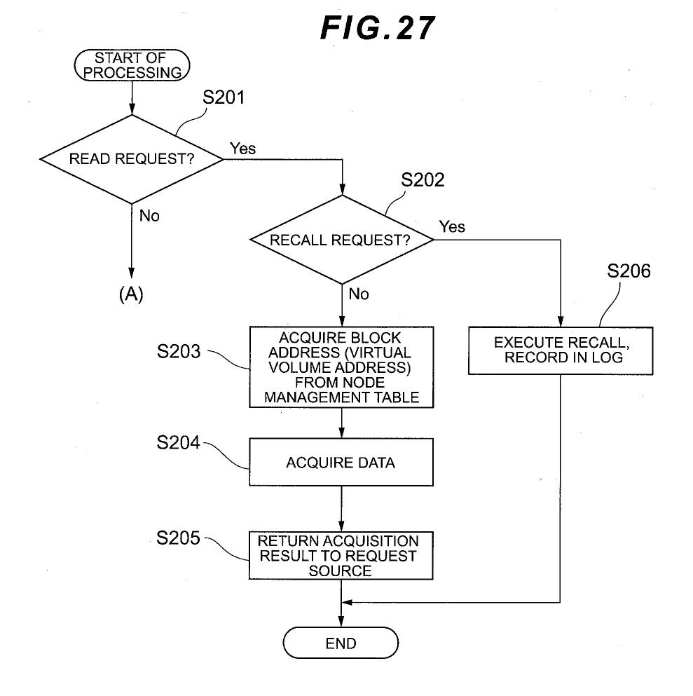

Processing to receive data read/write requests from the client/host 230 using the reception program 2233 will be explained next. As shown in FIG. 27, the reception program 2233 first determines whether or not the request from the client/host 230 is a data read request (S201). If it is determined in step S201 that the request is a data read request, the reception program 2233 determines whether or not the request is a recall request (S202). Here, a recall indicates the return of a migrated file entity.

If it is determined in step S202 that the request is a recall request, the reception program 2233 executes a recall and then records the target file name of the recall target and the date and time when the recall was executed in the access log 2290 (S206).

On the other hand, if it is determined in step S202 that the request is not a recall request, the reception program 2233 acquires the block address (virtual volume address) which is the read request target from the inode management table 2226 (S203). The reception program 2233 then acquires data stored at the real address of the logical volume (LDEV), which corresponds to the block address acquired in step S203, from the disk array device 210 (S204). Processing to acquire data in step S204 will be described in detail subsequently. The reception program 2233 then returns the acquisition result acquired in step S204 to the client/host 230 which is the request source (S205).

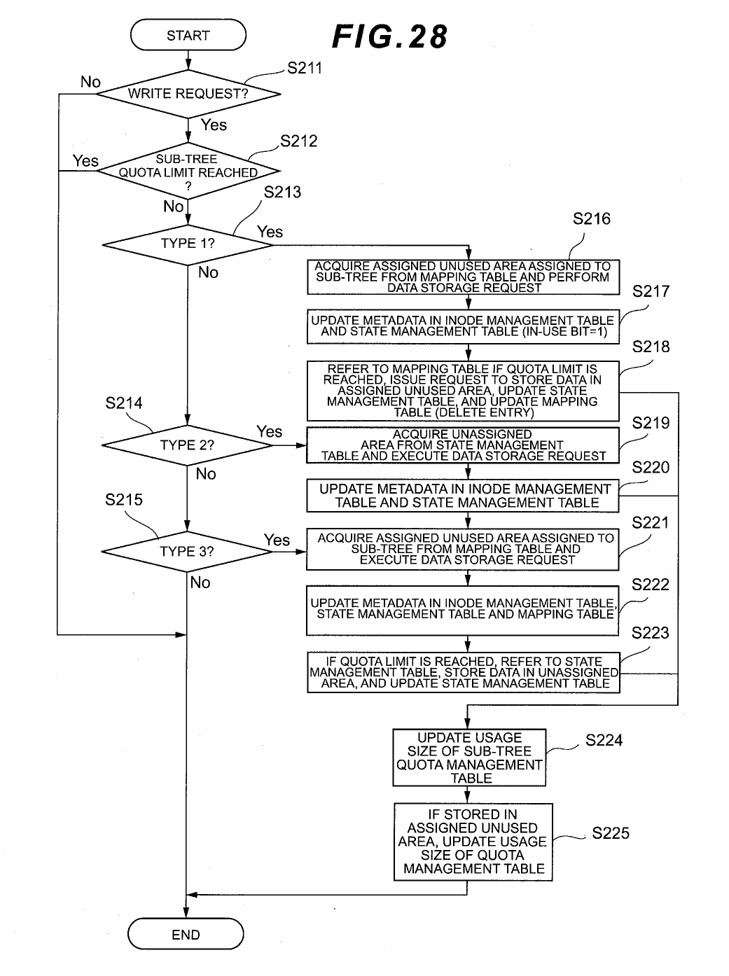

If it is determined in step S201 that the request is not a data read request, the reception program 2233 determines whether or not the request is a data write request as shown in FIG. 28 (S211). If it is determined in step S211 that the request is a data write request, the reception program 2233 determines whether or not the sub-tree quota limit has been reached (S212). In specific terms, the reception program 2233 refers to the quota value and usage size in the sub-tree quota management table 2240 to determine whether to write data to the sub-tree which is the write target.

If it is determined in step S212 that the sub-tree quota limit has been reached, the reception program 2233 ends the processing. However, if it is determined in step S212 that the sub-tree quota limit has not been reached, the reception program 2233 determines whether or not the sub-tree which is the data write target is a type-1 sub-tree (S213).

If a sub-tree which is a data write target is determined as a type-1 sub-tree in step S213, the reception program 2233 acquires an assigned unused area which is assigned to the write target sub-tree from the mapping table 2270 and executes the data storage request (S216). Processing to request storage of data in step S216 will be described in detail subsequently.

The reception program 2233 updates metadata such as update dates and times in the inode management table 2280 and updates the in-use bit in the state management table 2260 to 1 (S217). The reception program 2233 refers to the quota management table 2280 and if the quota limit has been reached, refers to the mapping table 2270 to perform a request to store data in an assigned unused area (S218). The reception program 2233 also updates the state management table 2260 and mapping table 2270.

Here, a case where the quota limit is reached is a case where the size of the write data is greater than the assigned unused area assigned to the relevant sub-tree, this case being one where data is stored in an assigned unused area which has not yet been assigned to any sub-tree. In addition, the in-use bit of the corresponding block address in the state management table 2260 is configured as 1. Furthermore, entries which have been registered as assigned unused areas are deleted from the mapping table 2270. The update processing of the mapping table 2270 in step S218 will be described in detail subsequently.

If it is determined in step S213 that the sub-tree which is the data write target is not a type-1 sub-tree, the reception program 2233 determines whether or not the sub-tree which is the data write target is a type-2 sub-tree (S214). If it is determined in step S214 that the sub-tree which is the data write target is a type-2 sub-tree, the reception program 2233 refers to the state management table 2260, acquires the block address of an unassigned area, and issues a request to store data in the area (S219). The processing to request storage of data in step S219 will be described in detail subsequently. The reception program 2233 then updates metadata such as update dates and times in the inode management table 2280 and updates the in-use bit of the state management table 2260 to 1 (S220).

If it is determined in step S214 that the sub-tree which is the data write target is not a type-2 sub-tree, the reception program 2233 determines whether or not the sub-tree which is the data write target is a type-3 sub-tree (S215). If it is determined in step S215 that a sub-tree which is a data write target is type 3, the reception program 2233 acquires assigned unused areas which are assigned to the write target sub-tree from the mapping table 2270 and executes the data storage request (S221). Processing to request storage of data in step S221 will be described in detail subsequently.

The reception program 2233 updates metadata such as update dates and times in the inode management table 2280 and updates the in-use bit in the state management table 2260 to 1 (S222). Furthermore, entries which have been registered as assigned unused areas are deleted from the mapping table 2270. The update processing of the mapping table 2270 in step S222 will be described in detail subsequently.

The reception program 2233 refers to the quota management table 2280 and if the quota limit has been reached, refers to the state management table 2260 to acquire the block address of an unassigned area, issues a request to store data in this area, and updates the state management table 2260 (S223).

Furthermore, after the processing of steps S218, S220, and S223 has ended, the reception program 2233 updates the usage size in the sub-tree quota management table 2240 (S224). Furthermore, if data is stored in the assigned unused areas, the reception program 2233 updates the usage size in the quota management table 2280 (S225).

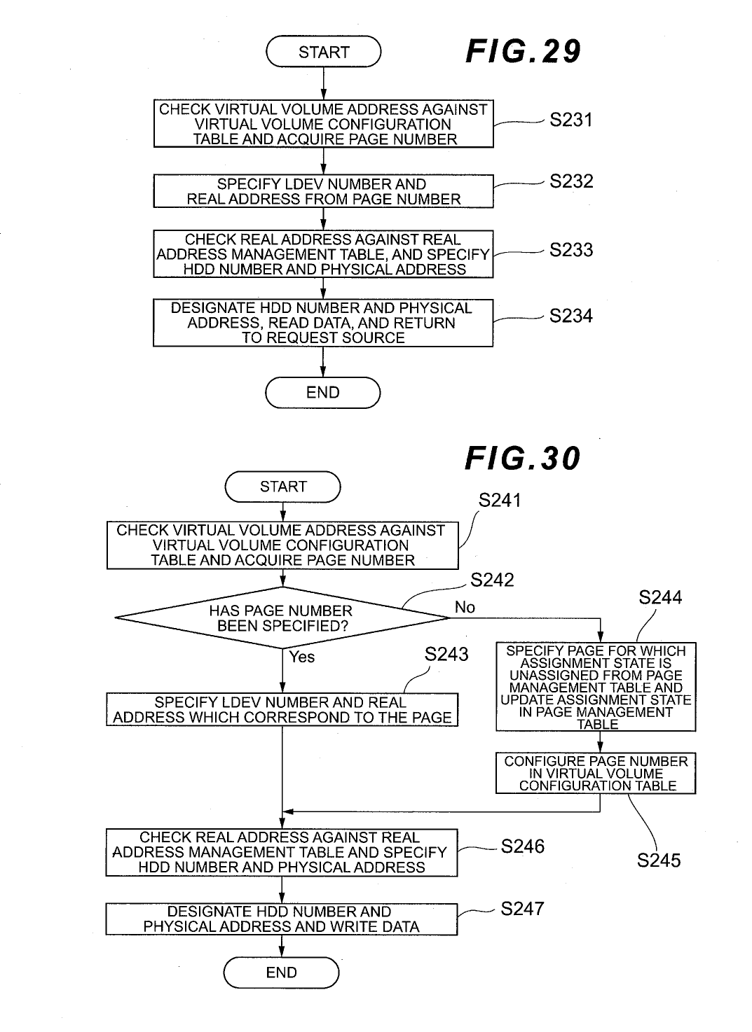

Processing to acquire data in step S204 will be described in detail subsequently. As shown in FIG. 29, the reception program 2233 first refers to the virtual volume configuration table 370 and acquires the page number corresponding to the acquired virtual volume address (S231). The reception program 2233 then refers to the page management table 360 and specifies the LDEV number and real address corresponding to the page number acquired in step S231 (S232).

The reception program 2233 then refers to the real address management table 380 and specifies the HDD number and physical address which correspond to the real address (S233). The reception program 2233 then designates the HDD number and physical address specified in step S233, reads the data, and then returns the reading result to the request source (S234).

The processing to store data in steps S216, S219, and S221 will be described subsequently. As shown in FIG. 30, the reception program 2233 first refers to the virtual volume configuration table 370 and acquires the page number corresponding to the acquired virtual volume address (S241). The reception program 2233 then determines whether or not the page number was specified in step S241 (S242).

If the page number was indeed specified in step S242, the reception program 2233 then refers to the page management table 360 and specifies the LDEV number and real address which correspond to the page number acquired in step S241 (S243). However, if the page number is not specified in step S242, the reception program 2233 refers to the page management table 360, specifies a page for which the assignment state is unassigned, and updates the assignment state of the page management table 360 (S244). The reception program 2233 then stores the page number in association with the corresponding virtual volume address in the virtual volume configuration table 370 (S245).

The reception program 2233 then refers to the real address management table 380 and specifies the HDD number and physical address which correspond to the real address (S246). The reception program 2233 then designates the HDD number and physical address specified in step S246 and performs data write processing (S247).

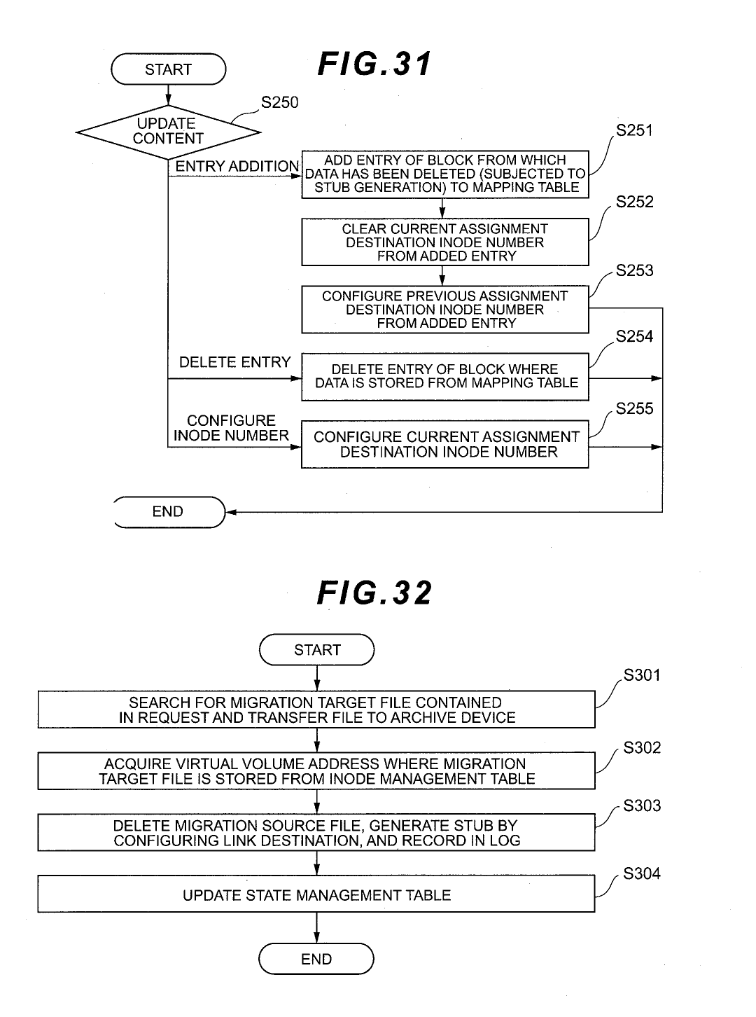

The update processing of the mapping table in steps S218 and S222 will be described next. As shown in FIG. 31, the reception program 2233 first determines any update content (S250). If it is determined in step S250 that the update entails the addition of an entry, the entry of a block from which data has been deleted due to stub generation is added to the mapping table 2270 (S251).

Furthermore, the reception program 2233 clears the current assignment destination inode number field 2272 of the mapping table 2270 for the entry added in step S251 (S252). The reception program 2233 then stores inode numbers of previously assigned sub-trees in the previous assignment destination inode number field 2273 in the mapping table 2270 for the entry added in step S251 (S253).

Furthermore, if it is determined in step S250 that the update entails the deletion of an entry, the reception program 2233 deletes the entry of a block in which data is stored from the mapping table 2270 (S254). Furthermore, if it is determined in step S250 that the update content entails the configuration of an inode number, the reception program 2233 configures the current assignment destination inode number of the corresponding block address in the mapping table 2270 (S255).

Data migration processing by the data mover program 2222 will be described next. As shown in FIG. 32, the data mover program 2222 first searches for a migration target file contained in the request from the system administrator or the like via a management terminal and transfers the migration target file to the archive device 320 (S301). Furthermore, the data mover program 2222 acquires a virtual volume address in which the migration target file is stored from the inode management table (S302).

Furthermore, the data mover program 2222 deletes a migration source file, configures a link destination and creates a stub, and records the stub in the access log 2290 (S303). More specifically, the data mover program 2222 records the target file name which is the stub generation target and the date and time when the stub generation was executed in the access log 2290.

The data mover program 2222 then updates the state management table 2260 (S304). More specifically, the data mover program 2222 configures 1 for the assignment bit of the block address in the state management table 2260 and 0 for the in-use bit. Thus, when 1 is configured as the assignment bit and 0 is configured for the in-use bit, 1 is configured in the assigned unused area. As a result, the area designated by the block address is the assigned unused area.

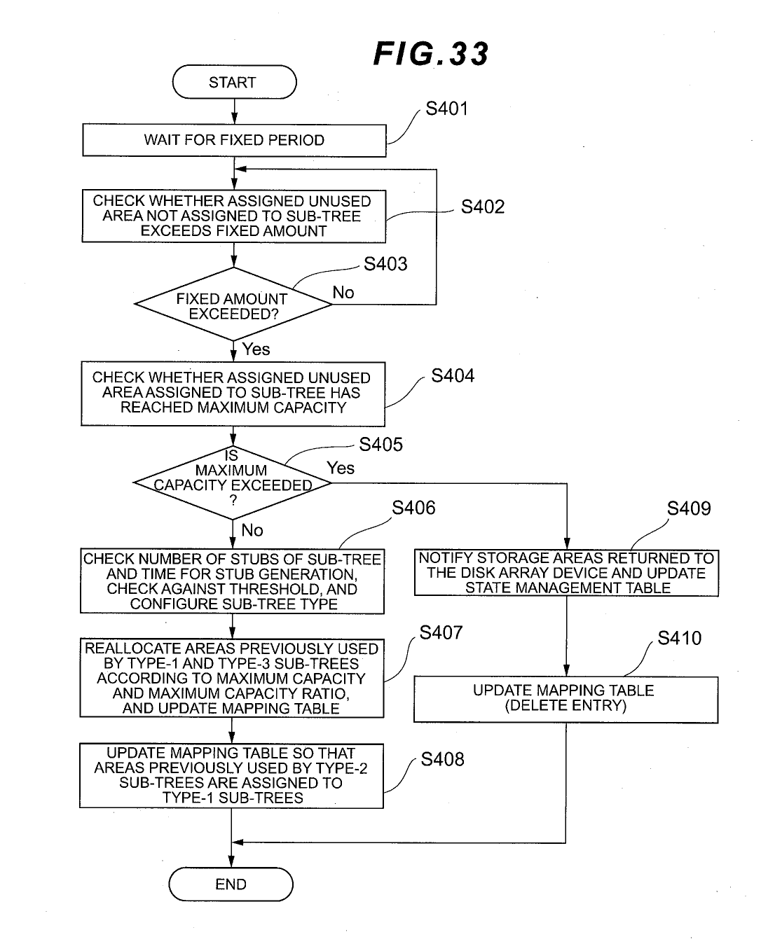

Processing for monitoring the assignment amount of the assigned unused area by the monitoring program 2234 will be described next. As shown in FIG. 33, the monitoring program 2234 first enters a fixed period standby state (S401). The monitoring program 2234 then checks whether the assigned unused area not assigned to a sub-tree exceeds a fixed amount (S402). The monitoring program 2234 then determines, based on the result of the check in step S402, whether the assigned unused area does not exceed a fixed amount (S403).

If it is determined in step S403 that the assigned unused area does not exceed the fixed amount, the monitoring program 2234 repeats the processing of step S402. In addition, if it is determined in step S403 that the assigned unused area exceeds the fixed amount, the monitoring program 2234 checks whether or not the assigned unused area assigned to a sub-tree has reached the maximum capacity (S404).

The monitoring program 2234 then determines, based on the result of the check in step S404, whether the assigned unused area has reached the maximum capacity (S405). If it is determined in step S405 that the assigned unused area has reached the maximum capacity, the monitoring program 2234 notifies the disk array device 210 of the storage area to be returned and updates the state management table 2260 (S409). More specifically, the monitoring program 2234 configures 0 for the assignment bit and in-use bit which correspond to the block address in the state management table 2260.

The monitoring program 2234 then updates the mapping table 2270 (S410). Specifically, the monitoring program 2234 deletes the entry of the relevant block address from the mapping table 2270.

However, if it is determined in step S403 that the assigned unused area exceeds a fixed amount, the monitoring program 2234 checks the number of sub-tree stubs and the time interval for stub generation, compares these values with a predetermined threshold and configures the sub-tree type (S406). The monitoring program 2234 then performs re-allocation of the assigned unused area, according to the maximum capacity and maximum capacity ratio of each sub-tree, on areas where a type-1 or type-3 sub-tree is used (S407). The monitoring program 2234 updates the mapping table 2270 after performing re-allocation of the assigned unused areas. Specifically, the monitoring program 2234 stores a re-allocation destination inode number in the current assignment destination inode number field 2272 of the mapping table 2270.

The monitoring program 2234 then performs assignment, to the type-1 first sub-tree, of the assigned unused area used by the type-2 second sub-tree (S408). The monitoring program 2234 updates the mapping table 2270 after assigning the assigned unused areas to the type-1 first sub-tree. Specifically, the monitoring program 2234 stores the type-1 sub-tree inode number assigned to the current assignment destination inode number field 2272 of the mapping table 2270.

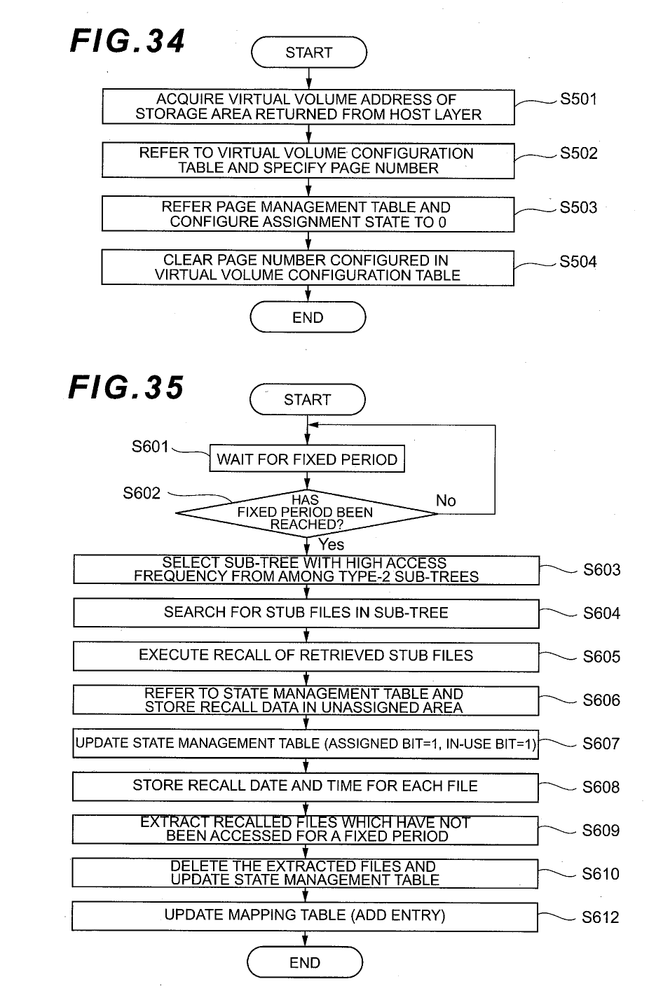

The storage area return reception processing which is executed in the disk array device 210 reported in S409 will be described next. As shown in FIG. 34, the microprogram 2102 of the disk array device 210 acquires the virtual volume address of the returned storage area (S501).

The microprogram 2102 refers to the virtual volume configuration table 370 and specifies the page number corresponding to the virtual volume address acquired in step S501 (S502).

The microprogram 2102 then refers to the page management table 360 and configures the assignment state of the page number specified in step S502 as 0 (S503). The microprogram 2102 clears the page number configured in the virtual volume configuration table 370 (S504).

The recall processing of the stub file in the sub-tree will be explained next by the prefetch/stub generation program 2235. As shown in FIG. 35, the prefetch/stub generation program 2235 first renders a fixed period standby state (S601). The prefetch/stub generation program 2235 then determines whether or not the standby state has reached a fixed period (S602). If the standby state has not reached the fixed period in step S602, the prefetch/stub generation program 2235 repeats the processing of step S601.

However, if it is determined in step S602 that the standby state has reached the fixed period, the prefetch/stub generation program 2235 selects a sub-tree with a high access frequency among the type-2 second sub-trees (S603). The prefetch/stub generation program 2235 searches for the stub file of the sub-tree selected in step S603 (S604).

The prefetch/stub generation program 2235 executes a recall of the stub file retrieved in step S604 (S605). The prefetch/stub generation program 2235 then refers to the state management table 2260 and stores the data that was recalled in step S605 in an unassigned area (S606).

The prefetch/stub generation program 2235 then updates the state management table 2260 after storing data in the unassigned area in step S606 (S607). More specifically, the prefetch/stub generation program 2235 configures 1 for the assignment bit of the block address and 1 for the in-use bit.

The prefetch/stub generation program 2235 then stores the recalled date in the access log 2290 for each file (S608). The prefetch/stub generation program 2235 then extracts a file which is a recalled file and for which there has been no access for a fixed period (S609).

The prefetch/stub generation program 2235 then updates the state management table 2260 by deleting the file which was extracted in step S609 (S610). More specifically, the prefetch/stub generation program 2235 configures 0 for the in-use bit of the block address in the state management table 2260. The prefetch/stub generation program 2235 then updates the mapping table 2270 (S612). More specifically, the prefetch/stub generation program 2235 adds the block address of an area which is an assigned unused area to the mapping table 2270.

Note that although steps S601 to S612 are executed as a series of processes hereinabove, the processing is not limited to this example; instead, the processing of steps S601 to S608 may be executed separately from the processing of steps S609 to S612. The file entities of sub-trees with a high access frequency among the type-2 second sub-trees can be returned by the processing of steps S601 to S608. Thereafter, the sub-trees with a low access frequency despite the file entities being restored after recall can be deleted by the processing of steps S609 to S612, and the area where these files are stored can be reserved as assigned unused area.

### (5) Effect of the Embodiment

As described hereinabove, with the storage system 100 according to this embodiment, a plurality of sub-trees are configured by limiting the directory usage capacities of each of the directories in the file system, and each sub-tree is handled as a single file system. If data is written to each sub-tree, a predetermined storage area of the logical volume defined by the plurality of hard disks is assigned and data is stored in this storage area. Here, when a predetermined storage area is assigned to a sub-tree which has undergone data writing, an assigned unused area which has been assigned to the sub-tree and is no longer being used is re-used. Furthermore, re-usage of the assigned unused area is limited according to the sub-tree usage characteristics. For example, assigned unused areas are proactively assigned to sub-trees with high data write frequencies, assigned unused areas are not assigned to sub-trees with a low data writing frequency, and storage areas which have not yet been assigned are assigned. In addition, assigned unused areas generated in a sub-tree with a low data writing frequency are re-used in a sub-tree with a high data writing frequency.

Thus, in this embodiment, if data is written to a sub-tree with a high data writing frequency, the time taken by pool storage area assignment processing can be shortened by re-using assigned unused areas. In addition, by re-using assigned unused area generated in a sub-tree with a low data writing frequency for a sub-tree with a high data writing frequency, assigned unused area can be utilized effectively. As a result, the load on the whole system in data write processing can be reduced and the processing performance can be improved.

### (6) Other Embodiments

Note that in the aforementioned embodiments, based on the various programs stored in the file storage device 220, the CPU 224 of the file storage device 220 implements various functions of the file system construction unit, assignment unit, and area management unit and so on of the present invention but is not limited to this example.

For example, various functions may also be implemented in co-operation with the CPU of the disk array device 210 as a storage apparatus which integrates the file storage device 220 and disk array device 210. In addition, various functions may be implemented by storing various programs stored in the file storage device 220 in the disk array device 210 and as a result of these programs being called by the CPU 224.

Furthermore, for example, each of the steps in the processing of the file storage device 220 and so on of this specification need not necessarily be processed in chronological order according to the sequence described as a flowchart. That is, each of the steps in the processing of the file storage device 220 may also be executed in parallel or as different processes.

Furthermore, the hardware installed in the file storage device 220 or the like such as the CPU, ROM and RAM can also be created by computer programs in order to exhibit the same functions as each of the configurations of the file storage device 220 described hereinabove. Moreover, a storage medium on which these computer programs are stored can also be provided.

### INDUSTRIAL APPLICABILITY

The present invention can be suitably applied to a storage system which enables the load in data write processing to be reduced by suitably re-using storage area assigned to a virtual volume according to the file system usage characteristics, thereby improving the processing performance.

### REFERENCE SIGNS LIST

100 Storage system
210 Disk array device
220 File storage device
2221 File sharing program
2222 Data mover program
2223 File system program
2224 Kernel/driver
2231 File system construction program
2232 Initial allocation program
2233 Reception program
2234 Monitoring program
2235 Prefetch/stub generation program
230 Client/host
310 Disk array device
320 Archive device
400 Network

1. A storage apparatus which is connected via a network to a host device which requests data writing, comprising:
a file system construction unit which constructs a file system on a virtual volume accessed by the host device;
an assignment unit which assigns a storage area of a plurality of storage devices to a data storage area of the file system in response to the data writing request from the host device; and
an area management unit which, once the storage area of the plurality of storage devices has been assigned at least once to the data storage area of the file system, manages an area of the storage area from which data has been deleted and is no longer used by the file system as an assigned unused area as is while maintaining the assignment of the storage area of the plurality of storage devices, wherein the assignment unit re-assigns the assigned unused area to the data storage area of the file system if the data writing to the data storage area of the file system from the host device has taken place.

2. The storage apparatus according to claim 1,
wherein the file system construction unit configures a predetermined capacity restriction for each directory of the file system and creates a plurality of sub-trees, and
wherein the assignment unit re-assigns the assigned unused area according to usage characteristics of the sub-trees.

3. The storage apparatus according to claim 2,
wherein the assignment unit classifies the sub-trees according to a frequency of the data writing from the host device, and re-assigns the assigned unused area to a first sub-tree for which the data writing frequency is higher than a first threshold.

4. The storage apparatus according to claim 3,
wherein the assignment unit re-assigns the assigned unused area generated in a second sub-tree, for which the data writing frequency is lower than a second threshold, to the first sub-tree.

5. The storage apparatus according to claim 3,
wherein the assignment unit re-assigns the assigned unused area generated in a third sub-tree, for which the data writing frequency is lower than the first threshold and higher than the second threshold, to the third sub-tree.

6. The storage apparatus according to claim 2,
wherein the area management unit manages the assigned unused area according to the usage characteristics of the sub-trees in association with the sub-trees beforehand.

7. The storage apparatus according to claim 2,
wherein the area management unit limits the usage capacity of the assigned unused area according to the usage characteristics of the sub-trees.

8. The storage apparatus according to claim 2,
wherein the file system construction unit manages the block address of the virtual volume and the inode numbers identifying the sub-trees in association with one another, and
wherein the area management unit registers, in the state management table in association with each other, the block address of the virtual volume, a flag indicating whether the area is the assigned unused area which is currently not being used and in which the block address has been previously assigned to the sub-trees, and a flag indicating whether the area is an unassigned area which has still not been assigned to the sub-trees.

9. The storage apparatus according to claim 8,
wherein the area management unit registers, in the mapping table in association with each other, the block address of the assigned unused area and the inode number of the sub-tree to which the assigned unused area has been assigned.

10. The storage apparatus according to claim 8,
wherein the area management unit registers, in the quota management table in association with each other, the inode numbers of the sub-trees, the usage capacity of the assigned unused area assigned to the sub-tree, and the restricted capacity of the assigned unused area which can be assigned to the sub-tree.

11. The storage apparatus according to claim 1,
wherein, if the data is made into a stub as a result of migration of the data, the assignment unit cancels assignment of the storage area of the plurality of storage devices assigned to the data storage area of the file system, and
wherein the area management unit manages the area for which assignment of the storage area of the plurality of storage devices has been canceled by the assignment unit as the assigned unused area.

12. A file system management method which employs a storage apparatus which is connected via a network to a host device that requests data writing, comprising: a step of constructing file systems in a virtual volume accessed by the host device, configuring a predetermined capacity restriction for each directory of the file systems and creating a plurality of sub-trees;
a step of assigning a storage area of a plurality of storage devices to a data storage area of the sub-trees in response to the data writing request from the host device;
a step of reserving, once the storage area of the plurality of storage devices has been assigned at least once to the data storage area of the file system, an area from which the data of the storage area has been deleted and which is no longer used by the file system, as an assigned unused area; and
a step of re-assigning the assigned unused area to the data storage area of the sub-tree according to the usage characteristics of the sub-trees if there has been data writing to the data storage area of the file system from the host device.
